(19) United States
(12) Patent Application Publication
(10) Pub. No.: US 2010/0272084 A1
(43) Pub. Date: Oct. 28, 2010

(54) ACCESS NODE SWITCHING METHOD

(75) Inventors: Philippe Herbelin, Vincennes (FR); Khadija Daoud Triki, Issy Les Moulineaux (FR); Jerome Pons, Paris (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: FRANCE TELECOM, Paris (FR)

(21) Appl. No.: 12/739,184

(22) PCT Filed: Oct. 24, 2008
(86) PCT No.: PCT/FR2008/051926

§ 371 Date: Apr. 22, 2010

(30) Foreign Application Priority Data
Oct. 26, 2007 (FR) 0758634

(51) Int. Cl. H04W 4/00

(52) U.S. Cl. 370/338

(57) ABSTRACT

A method of switching a terminal from a source access node (NA₁) to a destination access node (NA₂, NA₃, NA₄), which terminal (M) is using at least one service with a remote communicating entity (EC) via a packet-switched network (R_IP), the terminal being associated, when connected to the source access node, with a first communications context and with a set consisting of possible application configurations for using the service concerned, a communications context containing parameters relating to “lower” layers and parameters relating to “higher” layers defining a given application configuration, the layers being defined by a communications model, the method comprising a step (E2, E3) of discovering potential destination access nodes, a step (E4) of the source access node selecting one of the potential destination access nodes, and a step (E5) of transferring the first communications context of the terminal from the source access node to the selected destination access node.

The field of the invention is that of telecommunications and more precisely that of mobile radio communications networks.

The invention relates more particularly to switching the access node of a terminal while it is using one or more services in conjunction with one or more remote communicating entities via a packet-switched network. The terminal is initially connected to a source access node and is associated with a current communications context containing information relating to layers of a communications model that are required for using each service concerned in conjunction with a communicating entity. Because of its mobility, the terminal may need to switch from the source access node to a destination access node.

Note that the source and destination access nodes may be in the same access network or in different access networks. These may be access networks of cellular mobile networks, for example UMTS (Universal Mobile Telecommunications System) networks, wireless networks, for example WIMAX (World Interoperability for Microwave Access) networks or cable networks, for example FTTH (Fiber To The Home) networks. In any event, these access networks are connected to the packet-switched network, for example an IP (Internet Protocol) network supporting the service used by the terminal. Moreover, the terminal may be a monotechnology terminal, a multitechnology terminal, or a reconfigurable monotechnology terminal.

The remote communicating entity in conjunction with which the terminal is using the service concerned may be another user terminal or a remote server. In the former situation, the service used by the two terminals may be an IP telephony service, an instant messaging service, etc. In the latter situation, the remote server may provide the service used by the terminal.

Packets exchanged between the terminal and the remote communicating entity take a path including intermediate nodes. This path is modified in the event of the terminal switching from a source access node to a destination access node (this is known as handover).

The OSI model standardized by the ISO (International Standards Organization) is a communications model for managing transfer of data by means of a stack of seven layers: a physical layer (layer 1), a data link layer (layer 2), a network layer (layer 3), a transport layer (layer 4), a session layer (layer 5), a presentation layer (layer 6), and an application layer (layer 7). The nodes of telecommunications networks incorporate some or all of these layers. For its part, the terminal incorporates all seven layers of the OSI model. The first three layers, referred to as lower layers, relate to implementing the link and transporting the data, and in principle they are transparent as to the type of data transported. The next four layers, referred to as higher layers, are responsible for processing the data making it possible to offer the service offered by the network.

There exist other layered communications models, notably an IETF (Internet Engineering Task Force) model with five layers.

By definition, a communications context comprises all the information required to use a service and relating to all the layers of the communications model used, the transport context relating to the lower layers and the application context relating to the higher layers.

A subset of parameters of the application context defines a given application configuration for the service being used between the terminal and the remote communicating entity. These parameters are the type of service, the bit rate, and the type of coder/decoder activated when the service concerned is used via the source access node, for example.

In the lower layers, protocols are exchanged between the neighboring intermediate nodes, whereas in the higher layers protocols are exchanged between the terminal and the communicating entity, which may be separated by numerous intermediate nodes. The lower layers are thus chained along the path between the terminal and the remote communicating entity via intermediate nodes, whereas the higher layers are connected end-to-end.

In a system based on the OSI model, the access node to an access network incorporates the physical layer, the data link layer, and the network layer. The access node is for example a base station of a UMTS, HSDPA, or LTE (“Node B” or “Evolved Node B”) network or an access point of a WIMAX network.

The intermediate nodes upstream of the packet-switched telecommunications network incorporate some or all of the lower layers.

In a UMTS network, for example, the intermediate nodes are, successively, a radio network controller (RNC) base station, an SGSN (Serving GPRS Support Node) gateway, and a GGSN (Gateway GPRS Support Node) gateway that maintain a communications, context linked to the mobile terminal and to its applications in use. As UMTS networks have evolved, the functions of the controller have been split between the base stations and the gateways that constitute the intermediate nodes, referred to as SAE gateways and PDN gateways.

In WIMAX wireless networks, the intermediate nodes, for example the AGW gateways and routers implementing the mobile Internet Protocol (MIP) of the MIP network layer, generally incorporate the first three layers of the OSI model.

Generic access node switching procedures include a step of deciding on access node switching, a step of attaching the terminal to the destination access node by setting up a link on the data link layer, and a step of the equipments of the network associated with the destination access node determining and updating the path linking the terminal and the service node via the new access node.

Changing the access node is generally managed by using tunnels at the network layer level, for example using the GPRS Tunneling Protocol (GTP) or Mobile Internet Protocol (MIP). Using tunnels makes it possible to update the path to the terminal from an anchor point in the network and to render the change of access node transparent for the remote communicating entity, which is thus able to use the same network layer information, for example the IP address of the mobile terminal that was used to set up communication. However, the processes of setting up and maintaining tunnels and contexts linked to the mobile terminal are very greedy of memory resources in the intermediate nodes.

If several services are for use in conjunction with a plurality of communicating entities, all of the links between the terminal and the source access node are switched to the destination node.

A known solution for limiting the use of tunnels is based on using protocols at the transport layer level, for example the Stream Control Transmission Protocol (SCTP), or at the session layer level, for example the Session Initiation Protocol (SIP), which implement signaling messages notifying a change of mobile terminal IP address. Using such protocols increases the quantity of signaling exchanged and introduces latency times impacting on communication quality of service, especially for real-time services. These protocols are therefore not a satisfactory solution for access node switching. The paper entitled “Link Layer Assisted Mobility using SIP for real time multimedia communication” by Wooseong Kim, Myungchul Kim, Chansu Yu, and Ben Lee presented at the MobiWAC'04 conference envisages introducing an access node switching anticipation step, where appropriate with a predetermined new IP address relating to the connection to the destination access node. That anticipation undoubtedly reduces the latency time, but it does not improve the quality of service for the application or applications in use, for example by increasing the bit rate offered, because the destination node does not implement the higher layers and does not incorporate all possible application configurations for using the service in conjunction with the remote communicating entity.

This possible application configuration information may exist in some intermediate nodes, for example in an IMS (IP Multimedia Subsystem) architecture, but requires the use of additional signaling messages.

The invention therefore proposes a method of switching a terminal from a source access node to a destination access node, which terminal is capable of using at least one service via a packet-switched network, said terminal being associated, when connected to the source access node, with a first communications context and with a set consisting of at least one possible application configuration for using the service concerned.

The method comprises:
a step of discovering at least one potential destination access node, during which step:
   the source access node sends said at least one potential destination access node a resource request message indicating said set of possible application configurations; and
   the source access node receives in response from said at least one potential destination node at least one application configuration from the set of indicated possible application configurations for which resources can be provided;
a step of the source access node selecting one of said at least one potential destination nodes; and
a step of transferring the first communications context of the terminal from the source access node to the selected destination access node.

By definition, a communications context contains (the layers referred to being defined by a communications model):
parameters relating to “lower” layers; and
parameters relating to “higher” layers defining a given application configuration.

According to the invention, it is the source access node that:
stores a plurality of possible application configurations and the communications context of the mobile for using the service concerned in conjunction with the communicating entity, the communications context containing not only parameters relating to the lower layers but also the application context of the terminal; and
manages and monitors switching, i.e. changing access node.

This greatly reduces the latency time. Moreover, it makes it possible to choose the destination access node offering the most suitable application configuration from all possible configurations that have been communicated to it for using the service concerned in conjunction with the communicating entity. The destination node determines the appropriate application configuration on the basis of its available resources and its resource allocation policy, in order to offer the most suitable quality of service. Access node switching even makes it possible to improve the quality of service, notably by increasing the allocated bit rate or by adding a medium, for example by moving from a voice application to a videophone application, during the use of the service concerned, without interrupting it.

Note that the solution of the invention is particularly advantageous compared to the switching method described in patent document WO 03/092314, for example. According to that document, such a switching method is implemented in the terminal or in a network equipment known as a proxy.

According to one aspect of the invention, selecting a destination access node by the source access node, and also managing the connection and monitoring the call, make it possible to reduce the exchange of information between the terminal and the source and destination access nodes. This limits the load on the terminal compared to the switching method used in the terminal described in the above-mentioned document.

Furthermore, implementing the switching method in a proxy as described in the above-mentioned document greatly increases the latency time compared to the solution of the invention.

After the transfer step, the source access node receives from the selected destination access node at least one parameter relating to a second communications context of the terminal.

Thus the source access node is able to manage access node switching transparently for intermediate nodes between the terminal and the communicating entity.

The method further includes a step of the source access node notifying a remote communicating entity EC of at least one parameter received from the selected destination access node.

The communicating entity is then able to send and receive data packets from the selected destination access node. This anticipation of access node switching by the communicating entity therefore makes it possible to ensure continuity of service by reducing the latency times.

The method further includes a step of the source access node notifying the terminal of at least one parameter received from the selected destination access node.

The terminal may then reconfigure the parameters relating to the second communications context and is able to identify itself to the selected destination node.

The switching method in which the communications model used is the OSI reference model is based on the lower layers comprising the data link layer and the network layer and the higher layers comprising the transport layer, the session layer, the presentation layer, and the application layer. The substep of the source access node notifying the communicating entity of parameters relating to the second communications context uses a protocol of one of the higher layers.

The invention also provides a switching device for a source access node, which device is adapted to control the connection of a terminal capable of using at least one service via a packet-switched network, which terminal, when it is connected to the source access node, being associated with a first communications context and with a set consisting of at least one possible application configuration for using the service concerned. The device comprises:
means for discovering at least one potential destination access node adapted to:
   send said at least one potential destination access node a resource request message indicating said set of possible application configurations; and
   receive in response at least one application configuration of said at least one potential destination access node from the set of indicated possible application configurations for which resources can be provided;
means for selecting one of said at least one potential destination access nodes; and
means for commanding transfer of the first communications context of the terminal to said selected destination access node.

The invention also provides a switching device for a “destination” access node, which device, following access node switching, is able to take control of the connection of a terminal capable of using at least one service via a packet-switched network, which terminal, when it is connected to the source access node, being associated with a first communications context and with a set consisting of at least one possible application configuration for using the service concerned. The device comprises:
means for indicating to the source access node, in response to a resource request message indicating said set consisting of at least one possible application configuration, at least one application configuration from the set of indicated possible configurations, for which resources can be provided; and
means for receiving a first communications context of the terminal.

The invention further provides an access node connected to a packet-switched network including at least one of the two access mode switching devices of the invention.

The invention further provides a system comprising a plurality of access nodes of the invention connected to a packet-switched network.

The invention further provides a computer program including instructions for executing the method when that program is executed by a processor.

The invention further provides a computer program for a destination access node, which program includes program instructions for:
indicating to a source access node, in response to a resource request message indicating a set consisting of at least one possible application configuration, at least one application configuration from the set of indicated possible configurations, for which resources can be provided; and
receiving a first communications context of a terminal,
   when said program is executed by said destination access node.

The invention can be better understood with the assistance of the following description of the access node switching method of one particular implementation of the invention, given with reference to the appended drawings, which show one non-limiting implementation of the invention:

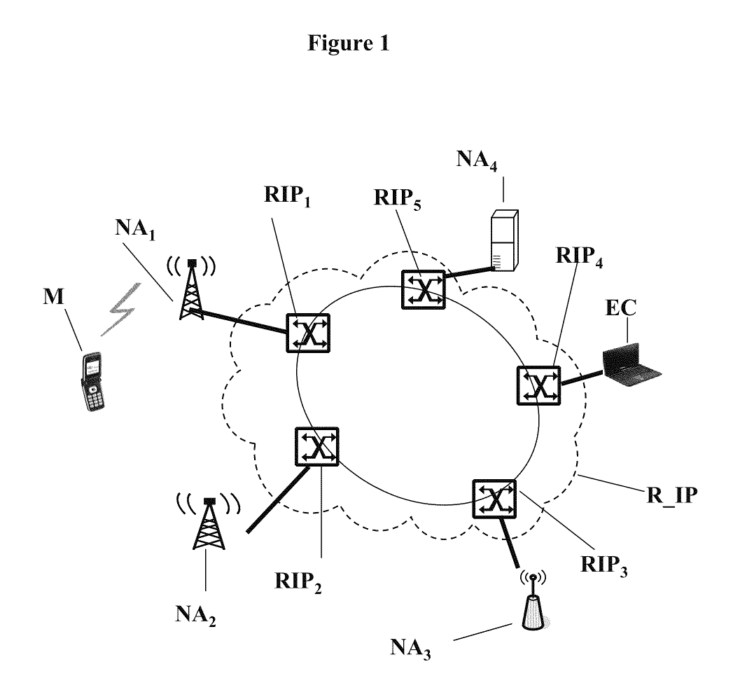

FIG. 1 represents a network architecture including access nodes of the invention;

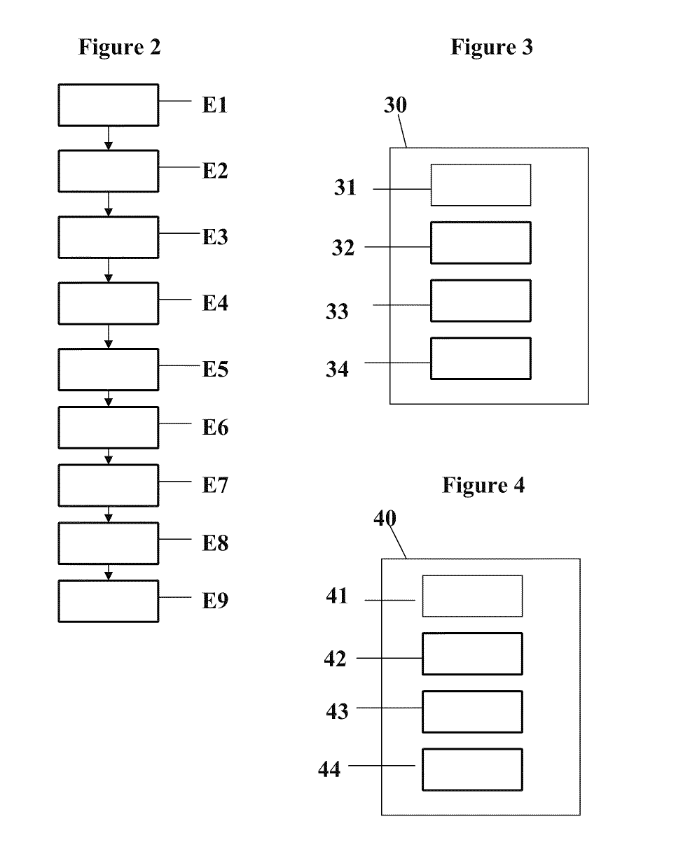

FIG. 2 represents an access node switching method of the invention;

FIG. 3 is a functional block diagram of a source access node of the invention; and

FIG. 4 is a functional block diagram of a destination access node of the invention.

FIG. 1 represents a telecommunications network architecture for setting up communication between a terminal M connected to an access node NAₗ and a communicating entity EC connected to a packet-switched network R_IP, the communicating entity EC offering a service to the terminal M via the packet-switched network. For clarity, only one communicating entity is shown in the figure, but there could obviously be more than one.

The communications network includes a plurality of access nodes. The access nodes may be in the same access network or in different access networks. For clarity, the access networks are not shown in FIG. 1. In FIG. 1, by way of non-limiting illustrative example, the access node NA₂ is a base station of a UMTS cellular mobile network, the access node NA₃ is an access point of a WiMAX wireless network, and the access node NA₄ is an access point of an FTTH cable network.

The access nodes and the communicating entity are connected to the packet-switched network by IP routers (RIP₁, RIP₂, RIP₃, RIP₄, RIP₅), for example. The communicating entity is an application server connected to the packet-switched network or a remote mobile terminal connected to an access network via an access node, for example.

In a system based on the OSI communications model, the terminal M connected to the access node NA₁ and the communicating entity incorporate the first three layers, numbered from 1 to 3, known as “lower layers” (physical layer, data link layer, network layer) concerned with providing the connection and transporting the data, and the next four layers, numbered from 4 to 7, known as “higher layers” (transport layer, session layer, presentation layer, application layer) responsible for processing data to execute applications for the provision of a service offered by the communicating entity via the packet-switched network R_IP.

The access nodes of the invention also incorporate the higher and lower layers of the OSI model, and are adapted to adapt messages of layers 1 to 7 exchanged between the terminal M and the communicating entity EC.

The method of one particular inmplementation of the invention for switching the access node of a terminal in communication with a communicating entity via a packet-switched network represented in FIG. 1 is described below with reference to FIG. 2.

Initially, the terminal is connected, or attached, to a source access node and is using a service in conjunction with a remote communicating entity via the packet-switched network. To use the service, the terminal executes one or more applications.

The terminal, connected to the source access node and using the service concerned, is associated with a first communications context and with a set of possible application configurations for using the service concerned. By definition, a communications context contains:
parameters relating to the “lower” layers of the OSI model; and
parameters relating to the “higher” layers of the OSI model defining a given application configuration.

By definition, an “application context” is the set of parameters relating to the higher layers of the communications context. A subset of parameters of the application context defines a given application configuration for the service used between the terminal and the remote communicating entity. For example, these parameters are the type of service, the bit rate, and the type of coder/decoder activated for the service concerned used via the source access node.

The method includes a first step E1 of the source access node identifying potential destination access nodes to which the terminal can be switched while using the service concerned. This step E1 is executed on reception by the source access node of information representing the quality of communications channels between the terminal M and the source access node and channels between the terminal and geographically adjacent access nodes. This information relates to layers 1 and 2 of the OSI model, for example. By way of non-limiting illustration, this information is the power level received by the terminal or a measured bit error rate. Based on the information received, the source access node establishes a list of potential destination access nodes. This list therefore includes adjacent nodes for which information relating to layer 1 or layer 2 is available.

Alternatively, the source access node selects from the list of adjacent nodes for which information relating to layer 1 or layer 2 is available a subset of destination access nodes for which the channels are of satisfactory quality, for example access nodes for which the power level is above a given threshold.

Using the information received during the step E1, the source access node determines in a step E2 the network layer characteristics of the potential destination access nodes, for example the IP addresses of the destination access nodes stored beforehand in the source access node or supplied to the access node by an equipment of the access network, depending on the architecture of the access network. The source access node then sends all the potential destination access nodes a resource request message indicating a set of possible application configurations for using the service concerned. For example, the information sent during this step E2 includes possible bit rates, possible coders/decoders, and the number and type of media supported, such as voice over IP or videoconference.

In a step E3, in response to the resource request message, the potential destination nodes advise the source node of at least one application configuration from the set of possible application configurations for which resources can be provided. To be more precise, a given destination node indicates the bit rate, the coder/decoder, and the type of media for which resources are available for continuing to use the service between the terminal and the remote communicating entity, for example.

Using the information received in the step E3, combined or not with the communications channel quality information obtained from the terminal before the step E1, in a step E4 the source access node selects a destination access node and then decides on the opportunity to switch from the source access node to the selected destination access node. The destination access node is advantageously selected by applying a criterion aiming to improve the quality of service perceived by the user of the terminal when moving around by proposing an application configuration better suited to the service in use in conjunction with the communicating entity, for example an increase in the bit rate offered or an increase in the number of media offered, such as switching from a voice application to a videophone application.

During a step E5, in the event of a decision to switch access node, the source access node transfers to the selected destination node all possible application configurations of the application and the first communications context of the terminal defining the information of layers 1 to 7 of the OSI model, i.e. the current communications context of the terminal connected to the source access node for using the service. The communications context can be transferred using the ConteXt Transfer Protocol (CXTP), for example.

The set of possible configurations of the application sent to the selected destination access node is stored by the node with a view to future switching of the terminal.

Alternatively, during the step E5, the source access node sends only the first communications context of the terminal, the destination access node then storing the set of possible application configurations communicated by the source node during the step E2.

The selected destination access node acknowledges the transfer of the first communications context of the terminal. It then determines a second communications context for the terminal. This is the new communications context, modified compared to the first and to be used by the terminal once connected to the destination access node selected for switching (handover). Then, during a step E6, the selected destination access node sends the source access node parameters relating to the second communications context of the terminal. This second communications context contains, for example, a new IP address of the terminal relating to the connection of the terminal to the selected access node and a new application configuration defining a new bit rate and/or a new coder/decoder for which resources are guaranteed by the selected destination access node. This new communications context can also contain the information of layers 1 and 2 to enable the terminal to be configured toward the destination access node. The selected destination access node thus sends the source access node either all the parameters relating to the second communications context of the terminal or only the parameters that have been modified relative to the first communications context.

Alternatively, the destination access node sends a subset of parameters of the new communications context needed only to set up the connection between the terminal and the communicating entity via the selected access node.

The source access node then executes access node switching in relation to the communicating entity in a step E7. During this step E7, it informs the remote communicating entity of the parameters relating to the higher layers (i.e. layers 4 to 7 of the OSI model) and the network layer (i.e. layer 3 of the OSI model) of the second communications context. The communicating entity can then send packets of data to the data access node in accordance with the application configuration defined in the second communications context. The source access node manages access node switching in relation to the remote communicating entity. The source access node uses a protocol of layer 4 or above for setting up a new session with the remote communicating entity, for example the Session Initiation Protocol (SIP). By way of illustration based on the SIP, the Back-to-Back User Agent (B2BUA) function for adapting the messages of layers 1 to 7 of the OSI model enables the communicating entity to be advised of an IP address modification and the new application configuration. The communicating entity is therefore informed of the change of access node and updates the information of layers 3 to 7 of the OSI model, for example with the new IP address of the terminal, in order to send and receive the network layer packets exchanged with the terminal in accordance with these new parameters.

During a step E8, after reception of an acknowledgement sent by the communicating entity confirming the recognition of the new (or second) communications context, the source access node informs the terminal that access node switching is being effected. It also sends the terminal the information relating to layers 1 to 7 of the new communications context, which is required to enable the terminal to be connected to the selected destination access node. This information includes in particular the new IP address of the terminal communicated by the destination node to the source node during the step E6, the information concerning layers 1 and 2 for preparing for its attachment to the destination access node, and information relating to the higher layers, such as the new application configuration.

In one particular version of the method, the step E7 of the source access node notifying the communication entity and the step E8 of the source access node notifying the terminal are effected simultaneously in order to accelerate access node switching.

During a step E9, after reconfiguring the parameters corresponding to all the layers of the communications model, the terminal is connected to the selected destination access node. The terminal is thus able to identify itself to the destination access node, which activates a session for transmission of data from or to the communicating entity.

One particular example of use of the method of switching the access node of a terminal in communication with a plurality of communicating entities via a packet-switched network is described below.

Initially, the terminal is connected, or attached, to a source access node and is using a plurality of services in conjunction with remote communicating entities via the packet-switched network. The terminal connected to the source access node and using the services concerned is associated with a plurality of first communications contexts and a plurality of possible application configurations. Each first communications context defines a given application configuration for a service between the terminal and a remote communicating entity.

The steps of the method described above are adapted to change the access node of the terminal after the potential access nodes indicate all the application configurations for using the services in conjunction with the remote communicating entities. In particular, as a function of the responses of the destination access nodes regarding the first communications contexts, the source access node selects a single destination node for all services being used in conjunction with the remote communicating entities.

In particular, during the step E7, the source access node executes access node switching with regard to all the communicating entities. During this step E7, it notifies each remote communicating entity of the parameters relating to the higher layers (i.e. layers 4 to 7 of the OSI model) and to the network layer (i.e. layer 3 of the OSI model) of a second communications context for use of the service between the terminal and the communicating entity concerned.

A source access node of the invention is described below with reference to FIG. 3 in which, for clarity, only the elements of the access node relating to the invention are represented.

The source access node is able to monitor the connection of a terminal using at least one service in conjunction with at least one remote communicating entity via a packet-switched network. It should be remembered that, when it is connected to the source access node, the terminal is associated with a first communications context and with a set of possible application configurations for using the service concerned.

The source access node includes an access node switching device 30 able to change the access node of a terminal in communication with a communicating entity via a packet-switched network in order to use a service. This device 30 is adapted to execute or to command execution of those steps of the method described above that are executed by the source access node. To be more precise, the module 30 includes the following elements:
block 31 for discovering potential destination access nodes;
a block 32 for selecting one of the potential destination access nodes;
a block 33 for modifying the current communications context of the terminal; and
a storage block 34.

The potential destination access node discovery block 31 is adapted:
to send the potential destination access nodes a resource request message indicating the set of possible application configurations for use of the service concerned by the terminal; and
to receive in response at least one application configuration, specified by the potential destination nodes, from the set of indicated possible application configurations for which resources can be provided.

It must be remembered that the application configuration is defined on the basis of parameters of the higher layers of the OSI model. For example, it defines the type of media, the type of coder/decoder or the bit rate.

The block 32 for selecting one of the potential destination access nodes is adapted to decide on a change of access node for the terminal using the service concerned in conjunction with the communicating entity and selecting a destination node from a set of potential destination nodes. Here this selection determines the access node offering an application configuration that is the most suitable for the service.

The block 33 for commanding modification of the current communications context of the terminal is adapted to command updating of the communications context of the terminal with a view to switching it to the potential destination access node. The block 33 is adapted:
to command transfer to the selected destination access node of the first communications context of the terminal (i.e. the communications context of the terminal when it is connected to the source access node and is using the service);
to receive from the selected destination node parameters of a second communications context of the terminal (i.e. that to be used by the terminal after switching);
to notify the terminal of the parameters relating to the second communications context; and
to notify the remote communicating entity of the parameters relating to the second communications context.

The block 33 is moreover adapted to notify the terminal of the new communications context.

The storage block 34 is adapted to store all possible application configurations associated with a terminal for using a service offered by a remote communicating entity via a packet-switched network.

A destination access node of the invention is described below with reference to FIG. 4, in which, for clarity, only the elements of the access node relating to the invention are represented.

The destination access node includes an access node switching device 40. This destination node can, following access node switching, take control of the connection of a terminal using at least one service in conjunction with at least one remote communicating entity via a packet-switched network. The device 40 is able to execute those of the steps of the method that are executed by the selected potential destination node. To be more precise, the device 40 includes the following elements:
a sending block 41 for specifying, in response to a resource request message indicating a set of possible application configurations for the terminal to use the service concerned, at least one application configuration from the set of indicated application configurations for which resources can be provided;
a block 42 for receiving a first communications context from the source access node;
a block 43 for determining a second (or new) communications context of the terminal; and
a block 44 for sending the source access node parameters of the second communications context of the terminal determined in this way.

The invention described here relates to an access node changing device implemented in the module 30 and in the module 40. Consequently, the invention applies equally to a computer program adapted to implement the invention, notably a computer program on or in an information storage medium. This computer program can use any programming language and take the form of source code, object code or a code intermediate between source code and object code, such as a partially-compiled form, or any other form suitable for implementing the method of the invention.

The information medium can be any entity or device capable of storing the program. For example, the medium can include storage means or a storage medium storing the computer program of the invention, such as, but not limited to, a ROM, for example a CD ROM or a micro-electronic circuit ROM, or a USB key, or magnetic storage means, for example a floppy disk or a hard disk, or a smart card.

1. A method of switching a terminal from a source access node to a destination access node, which terminal is capable of using at least one service via a packet-switched network, said terminal being associated, when connected to the source access node, with a first communications context and with a set consisting of at least one possible application configuration for using the service concerned, said method comprising the steps:
discovering at least one potential destination access node, during which step:
the source access node sends said at least one potential destination access node a resource request message indicating said set of possible application configurations; and
the source access node receives in response from said at least one potential destination node at least one application configuration from the set of indicated possible application configurations for which resources can be provided;
the source access node selecting one of said at least one potential destination nodes; and
transferring the first communications context of the terminal from the source access node to the selected destination access node.

2. The method according to claim 1, wherein, after the transfer step, the source access node receives from the selected destination access node at least one parameter relating to a second communications context of the terminal.

3. The method according to claim 2, comprising a step of the source access node notifying a remote communicating entity of at least one parameter received from the selected destination access node.

4. The method according to claim 2, comprising a step of the source access node notifying the terminal of at least one parameter received from the selected destination access node.

5. A switching device for a source access node, which device is adapted to control the connection of a terminal capable of using a service via a packet-switched network, which terminal, when it is connected to the source access node, being associated with a first communications context and with a set consisting of at least one possible application configuration for using the service, said device comprising:
means for discovering at least one potential destination access node adapted to:
send said at least one potential destination access node a resource request message indicating said set of possible application configurations; and
receive in response at least one application configuration of said at least one potential destination access node from the set of indicated possible application configurations for which resources can be provided;
means for selecting one of said at least one potential destination access nodes; and
means for commanding transfer of the first communications context of the terminal to said selected destination access node.

6. A switching device for a destination access node, which device, following access node switching, is able to take control of a connection of a terminal capable of using at least one service via a packet-switched network, which terminal, when it is connected to the source access node, being associated with a first communications context and with a set consisting of at least one possible application configuration for using the service, said device being comprising:
means for indicating to the source access node, in response to a resource request message indicating said set consisting of at least one possible application configuration, at least one application configuration from the set of indicated possible configurations, for which resources can be provided; and
means for receiving a first communications context of the terminal.

7. An access node connected to a packet-switched network including the switching device according to claim 5.

8. A system including a plurality of access nodes, according to claim 7 connected to a packet-switched network.

9. A computer program comprising instructions for executing the method of claim 1 when that program is executed by a processor.

10. A computer program for a destination access node, which program includes, said program comprising program instructions for:
indicating to a source access node, in response to a resource request message indicating a set consisting of at least one possible application configuration, at least one application configuration from the set of indicated possible configurations, for which resources can be provided; and
receiving a first communications context of a terminal, when said program is executed by said destination access node.

11. An access node connected to a packet-switched network including the switching device according to claim 6.

12. An access node connected to a packet-switched network including the switching device according to claim 11.
